(19) United States
(12) Patent Application Publication
(10) Pub. No.: US 2016/0204450 A1
(43) Pub. Date: Jul. 14, 2016

(54) Battery

(71) Applicant: Crown Master Technology Limited, Kowloon (HK)

(72) Inventor: Kung Jui Lee, Macau (CN)

(73) Assignee: Crown Master Technology Limited

(21) Appl. No.: 14/991,547

(22) Filed: Jan. 8, 2016

(30) Foreign Application Priority Data
Jan. 14, 2015 (HK) 15100421.2

(51) Int. Cl. H01M 6/32; H01M 6/02

(52) U.S. Cl. CPC H01M 6/32; H01M 6/02

(57) ABSTRACT

A battery body has opposite ends; a liquid-activatable powder mixture disposed therein; a positive electrode rod with a first end located adjacent a first end of the body and extends towards a second end of the body in contact with the powder mixture; a negative electrode, at which anions are oxidized, including a metal casing which has a first end located adjacent the first end of the body and extends towards the second end of the body; a permeable separator, disposed between the liquid-activatable powder mixture and the metal casing, for electrically isolating the negative electrode from the positive electrode while being permeable to liquid useful in activating the powder mixture; and a passage, extending between the first and second end of the body, for allowing a flow of liquid to activate the liquid activatable powder mixture.

The present invention relates to a battery that is particularly but not exclusively of re-useable battery activated by addition of a liquid.

### BACKGROUND OF THE INVENTION

Conventional batteries activated by a liquid would address the problem of long term storage resulting in inactivation and deterioration. The activation of such batteries requires addition of liquid usually by way of soaking the battery in a bath of liquid. The liquid molecules in the liquid spontaneously move through a partially permeable membrane into the interior of the battery by osmosis. The rate of movement of the liquid molecules tends to be slow. This is particularly undesirable when an emergency situation arises requiring urgent functioning of the battery.

In order to address the problem, a tool is required to inject liquid into the battery casing via a small aperture at one end of the battery. The liquid is under pressure to speed up movement across the permeable membrane. As an improvement, grooves are provided along length of a liquid-tight casing act as temporary storages of diminutive amount of liquid to be moved through a permeable separator sheet. However, these are less desirable given their limitations. The tightly packed ingredients add to the problem.

A cap is usually provided to cover the opening through which liquid enters the battery. The cap is easily lost or constitutes a small part swallow-able by young children rendering its use unfit for toy designed to the entertainment of children at certain age.

A further problem associated with current liquid-activated battery is the limitation of the energy output by the size of the battery.

The invention seeks to mitigate or at least alleviate such shortcomings by providing a new or improved battery.

### SUMMARY OF THE INVENTION

According to the invention, there is provided a battery comprising a body having opposite first and second ends; a liquid-activatable powder mixture disposed in the body; a positive electrode, to which cations migrate, comprising a conductive rod which has a first end located adjacent the first end of the body and extends towards the second end of the body in contact with the powder mixture; a negative electrode, at which anions are oxidized, comprising a metal casing which has a first end located adjacent the first end of the body and extends towards the second end of the body; a permeable separator, disposed between the liquid-activatable powder mixture and the metal casing, for electrically isolating the negative electrode from the positive electrode while being permeable to liquid useful in activating the powder mixture; and a passage, extending between the first and second end of the body, for allowing a flow of liquid to activate the liquid activatable powder mixture, wherein the metal casing is perforated and the passage includes at least one perforation on the metal casing and a cavity which is in communication with the perforation and positioned between the body and the metal casing.

Preferably, the first end of the body and the first end of the metal casing are sealed by a first end cap.

More preferably, the first end cap includes a first metal end cap which forms part of the positive electrode.

Yet more preferably, the first end cap includes an aperture in which the first metal end cap protrudes and in which the first end of the conductive rod embeds.

Advantageously, the second end of the body is closable by a second end cap which is openable from the second end of the body for allowing introduction of said liquid through the second end into the cavity to activate the liquid-activatable powder mixture.

More advantageously, the cavity extends substantially around the metal casing.

Yet more advantageously, the metal casing includes a second end adjacent the second end of the body, the at least one perforation on the metal casing elongates substantially across the first and second ends.

Preferably, the at least one perforation is die casted on a metal sheet which is rolled to form the metal casing, such that the perforation is spiral.

More preferably, the flow of liquid is made possible by a further passage which extends directly through a portion of the liquid permeable separator that continues beyond the metal casing.

Preferably, the portion of the liquid permeable separator extends substantially across the second end of the body for isolating the reactive mixture from external environment.

Advantageously, the second end cap is permanently physically connected to the rest of the battery.

More advantageously, the second end cap remains physically connected by action of an anchor acting against the metal casing.

Yet more advantageously, the second end cap includes a second metal end cap which forms part of the negative electrode.

Preferably, the second metal end cap has first and second opposite ends, the first end being physically connected with the second end of the metal casing and the second end being extended beyond the second end cap for establishing electric contact with an external load.

More preferably, the first end of the second metal end cap is physically to the second end of the metal casing by a resilient deformable member.

Advantageously, the resilient deformable member is physically connected to the second end of the metal casing through the anchor.

More advantageously, the anchor includes a resiliently deformable portion and wherein the second end of the metal casing includes a flange which defines an aperture, such that the resiliently deformable portion of the anchor is deformable for insertion through the aperture and expandable for retaining the anchor.

Yet more advantageously, the resiliently deformable portion is shaped to act against the flange at least when the second end cap is pulled away from the second end of the metal casing.

Preferably, the resilient deformable member is electrically conductive such that the second metal end cap is physically and electrically connected to the second end of the metal casing by the resilient deformable member.

More preferably, the anchor is electrically conductive such that the second metal end cap is physically and electrically connected to the second end of the metal casing by the anchor and the resilient deformable member.

Yet more preferably, the resiliently deformable member comprises a helical spring.

Advantageously, the anchor lies against the portion of the liquid permeable separator.

More advantageously, the further passage includes an aperture which is defined in the anchor and is in alignment with an aperture which is defined at the second end of the metal casing, the apertures being openable to the external environment when the second end cap is opened to permit the flow of liquid through the further passage.

Preferably, the reactive mixture is in the form of compacted lumps of reactive ingredients in powder form, each in a preferred dimension.

More preferably, each compacted lump takes the shape of a ball with an average diameter from 0.1 to 0.8 millimeters.

Yet more preferably, each compacted lump has a density of 1.0 to 2.0 g/cm³.

In another aspect of the invention there is provided a battery comprising a body having first and second ends, the second end being releasably sealable by a second end cap; a liquid-activatable powder mixture disposed in the body; a positive electrode, to which cations migrate, including a conductive rod in contact with the powder mixture and having a first end located adjacent the first end of the body and extending towards the second end of the body; a negative electrode, at which anions are oxidized, including a metal casing having a first end located adjacent the first end of the body and extending towards the second end of the body; a permeable separator disposed between the liquid-activatable powder mixture and the metal casing for electrically isolating the negative electrode from the positive electrode while being permeable to liquid useful in activating the powder mixture; and a passage extending between the first and second end of the body for allowing flow of said liquid to activate the liquid-activatable powder mixture, the passage being accessible by opening of the second end cap; wherein the second end cap is permanently physically connected to the rest of the battery and is closable with the second end of the body and is openable from the second end of the body for allowing introduction of said liquid through the second end into the body to activate the liquid-activatable powder mixture.

Preferably, the second end cap remains physically connected by action of an anchor acting against the metal casing.

More preferably, the second end cap includes a second metal end cap which forms part of the negative electrode.

Yet more preferably, the second metal end cap has first and second opposite ends, the first end being physically connected with the second end of the metal casing and the second end being protruded from the second end cap for establishing contact with an external load.

Advantageously, the first end of the second metal end cap is physically connected to the second end of the metal casing by a resilient deformable member.

More advantageously, the resilient deformable member is physically connected to the second end of the metal casing through the anchor.

Yet more advantageously, the anchor includes a resiliently deformable portion and wherein the second end of the metal casing includes a flange which defines an aperture, such that the resiliently deformable portion of the anchor is deformable for insertion through the aperture and expandable for retaining the anchor.

Preferably, the resiliently deformable portion is shaped to act against the flange at least when the second end cap is pulled away from the second end of the metal casing.

More preferably, the resilient deformable member is electrically conductive such that the second metal end cap is physically and electrically connected to the second end of the metal casing by the resilient deformable member.

Yet more preferably, the anchor is electrically conductive such that the second metal end cap is physically and electrically connected to the second end of the metal casing by the anchor and the resilient deformable member.

It is preferable that the resiliently deformable member comprises a helical spring.

In a further aspect of the invention there is provided a battery comprising a body having first and second ends; a liquid-activatable powder mixture disposed in the body; a positive electrode, to which cations migrate, including a conductive rod in contact with the powder mixture and having a first end located adjacent the first end of the body and extending towards the second end of the body; a negative electrode, at which anions are oxidized, including a metal casing having a first end located adjacent the first end of the body and extending towards the second end of the body; a permeable separator disposed between the liquid-activatable powder mixture and the metal casing for electrically isolating the negative electrode from the positive electrode while being permeable to said liquid useful in activating the powder mixture; and a passage extending between the first and second end of the body for allowing flow of said liquid to activate the liquid activatable powder mixture; wherein the liquid-activatable powder is in the form of compacted lumps, each in a preferred dimension.

Preferably, the compacted lump is in the form of a compacted ball which has an average diameter of 0.1 to 0.8 mm.

More preferably, the compacted ball has a reactive mixture powder density of about 1.0 to 2.0 g/cm³.

Yet more preferably, the metal casing is pre-treated with indium chloride.

Advantageously, the metal casing is soaked into a bath of indium chloride.

### BRIEF DESCRIPTION OF DRAWINGS

The invention will now be more particularly described, by way of example only, with reference to the accompanying drawings, in which:

FIG. 1a is a schematic illustration of an embodiment of a battery in accordance with the invention;

FIG. 1b is a schematic cross-sectional view of the battery in FIG. 1a;

FIGS. 1c and 1d are schematic side views of the battery in FIG. 1a;

FIG. 1e is an enlarged illustration of part A in FIG. 1b;

FIG. 2a is a schematic illustration of a body casing of the battery in FIG. 1a;

FIG. 2b is a schematic cross-sectional view of the body casing in FIG. 2a;

FIGS. 2c and 2d are schematic side views of the body casing in FIG. 2a;

FIG. 3a is a schematic illustration of a first metal end cap of the battery in FIG. 1a;

FIG. 3b is a schematic cross-sectional view of the first metal end cap in FIG. 3a;

FIGS. 3c and 3d are schematic side views of the first metal end cap in FIG. 3a;

FIG. 4a is a schematic illustration of a second end cap of the battery in FIG. 1a;

FIG. 4b is a schematic cross-sectional view of the second end cap in FIG. 4a;

FIGS. 4c and 4d are schematic side views of the second end cap in FIG. 4a;

FIG. 5a is a schematic illustration of a second metal end cap of the battery in FIG. 1a;

FIG. 5b is a schematic cross-sectional view of the second metal end cap in FIG. 5a;

FIGS. 5c and 5d are schematic side views of the second metal end cap in FIG. 5a;

FIG. 6a is a schematic front view of an anchor of the battery in FIG. 1a;

FIG. 6b is a schematic cross-sectional view of the anchor in FIG. 6a;

FIG. 7 is a schematic front view of a resiliently deformable connector of the battery in FIG. 1a;

FIGS. 8a, 8c and 8d are schematic illustrations of a metal casing of the battery in FIG. 1a;

FIG. 8b is a schematic cross-sectional view of the metal casing in FIGS. 8a, 8c and 8d;

FIG. 8e is a schematic side view of the metal casing in FIGS. 8a, 8c and 8d;

FIG. 8f is a schematic view of a die cast metal sheet for forming the metal casing in FIGS. 8a, 8c and 8d;

FIG. 8g is an enlarged view of part A in FIG. 8b;

FIG. 8h is an enlarged view of part B in FIG. 8b;

FIG. 8i is an enlarged view of part C in FIG. 8b;

FIG. 9 is a schematic cross-sectional view of a permeable separator of the battery in FIG. 1a;

FIG. 10 is a schematic illustration of a conductive rod of the battery in FIG. 1a;

FIG. 11a is a schematic illustration of a method of assembling the battery in FIG. 1a;

FIG. 11b is an enlarged schematic illustration of part A in FIG. 11a; and

FIG. 11c is an enlarged schematic illustration of part B in FIG. 11a.

### DETAILED DESCRIPTION OF PREFERRED EMBODIMENTS

Referring to the drawings, there is shown a liquid-activated battery 100 embodying the invention for use as energy storage. The battery 100 remains inactivate until a liquid such as water or any other suitable water-based liquid is added to it. Cutting through the inactivated battery will not cause it to explode rendering it particularly safe to use. The battery remains inactive during storage which mitigates the problem of convention batteries which tend to deteriorate immediately upon manufacture. When water is delivered into the battery 100 and reaches a liquid-activatable powder mixture 104 disposed in the battery 100, the powder mixture 104 and the battery 100 become activated to generate a potential difference between electrically-isolated positive and negative electrodes of the battery which may then be used as an electrical power source. The features and operation of this embodiment will be described in detail as follows.

The battery 100 is generally cylindrical in shape and includes a body 101, preferably in the form of an outer plastic casing, containing a metal casing 102, preferably perforated, which is lined in its inner surface by a liquid permeable separator 103, preferably a paper membrane. A liquid-activatable reaction mixture 104, preferably a powder mixture or compacted lumps of powder, is physically and electrically isolated from inner surface of the metal casing 102 by the liquid permeable separator 103. A core in the form of a carbon stick 105 extends inwardly of the metal casing 102 substantially horizontally and is embedded within/in contact with the reaction mixture 104.

Cathode (positive electrode to which cations migrate) of the battery 100 includes the carbon stick 105, also commonly known as the conductive rod, surrounded by manganese dioxide and a first metal cap 106, preferably copper cap, provided at a first end 101a of the plastic casing 101 and fit onto a first end of the carbon stick 105a. The first copper cap 106 together with the first end of the carbon stock 105a extend outwardly of the first end 101a of the plastic casing 101 via an aperture 1011 in the first end 101a. Anode (negative electrode at which anions are oxidized) of the battery 100 includes the metal casing 102 and a second metal cap 107 electrically connected thereto. The second metal cap 107 and the second end 102b of the metal casing 102 are both provided adjacent the second end 101b of the plastic casing 101 and are electrically connected.

Once water contacts with the reaction mixture 104, the reaction mixture chemically reacts to generate a potential difference between the cathode and the anode. The cathode and anode are separated from each by the liquid permeable separator 103 which physically and electrically isolates the cathode and anode of the battery 100 but permitting free flow of positive ions created as a result of the chemical reactions from the anode towards the cathode so as to generate and maintain the potential difference. Electrons formed at the anode electrode are therefore able to flow from the anode through a load device back to the cathode.

When the potential difference across the battery 100 falls below a usable level, liquid can be re-filled into the battery 100 to reactivate the reaction mixture 104 and regenerate a usable potential difference across the cathode and anode.

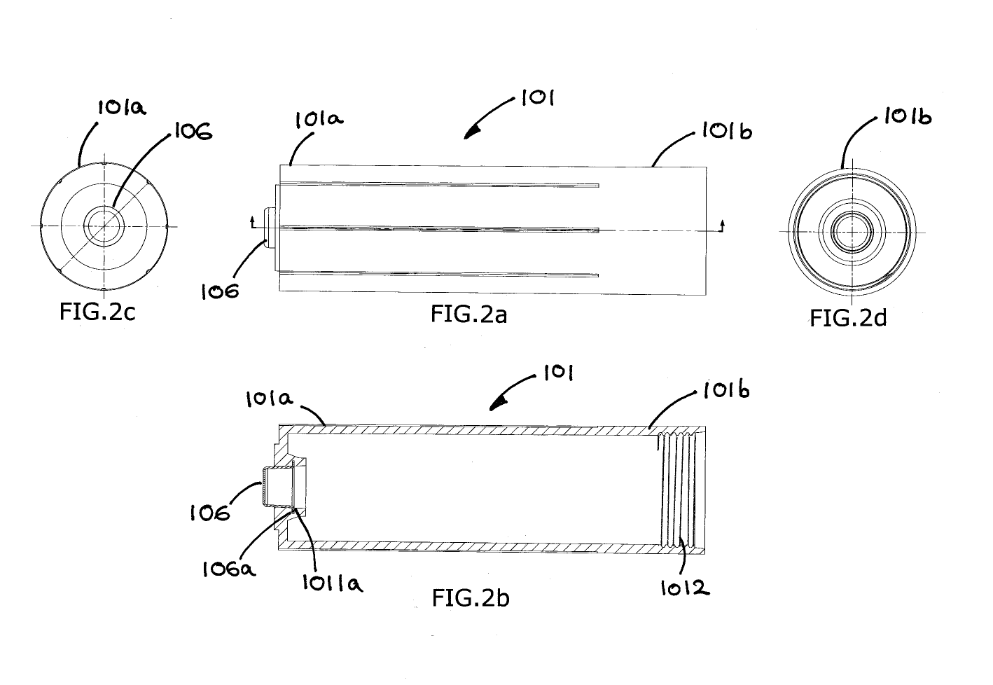

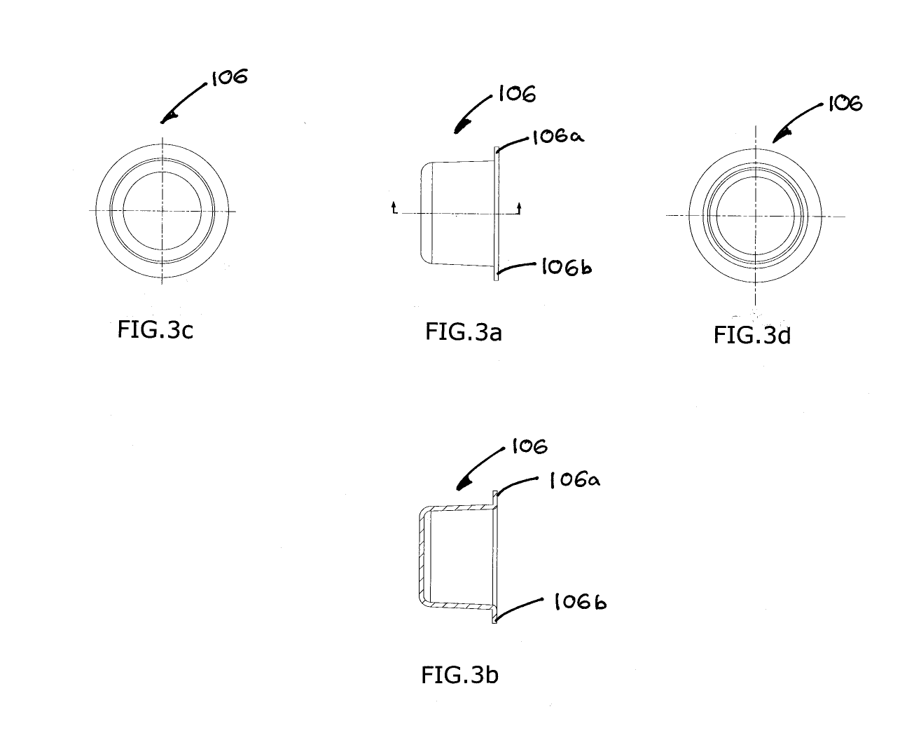

Referring to FIGS. 2a to 3d, the plastic casing 101 surrounds the metal casing 102 for reinforcement and protection against deformation due to stress or heat. The plastic casing 101 is made of plastic material for example Acrylonitrile butadiene styrene (ABS) which is performed, moulded and/or adapted to slide over the metal casing 102 as an outer sleeve. The plastic casing 101 has the aperture 1011 at its first end cap sealing the first end 101a which fits neatly over the first end 105a of the carbon stick 105 and the first metal cap 106. In the preferred embodiment, the first metal cap 106 has two legs with retaining means 106a inserted into grooves 1011a in an interior peripheral surface of the aperture 1011 for retaining thereon. The second end 101b of the plastic casing 101 is open ended with a threaded inner periphery 1012 for threadedly and releasably coupled to a second end cap 1013 which contains the second metal cap 107. As shown in FIGS. 2a to 2d, external periphery of the plastic casing 101 has a plurality of evenly spaced parallel grooves running generally from the first end 101a towards the second end 101b. These grooves assist gripping of the plastic casing 101. The external periphery of the plastic casing 101 is relatively easy to decorate with commercial indicators and information relative to the battery 100.

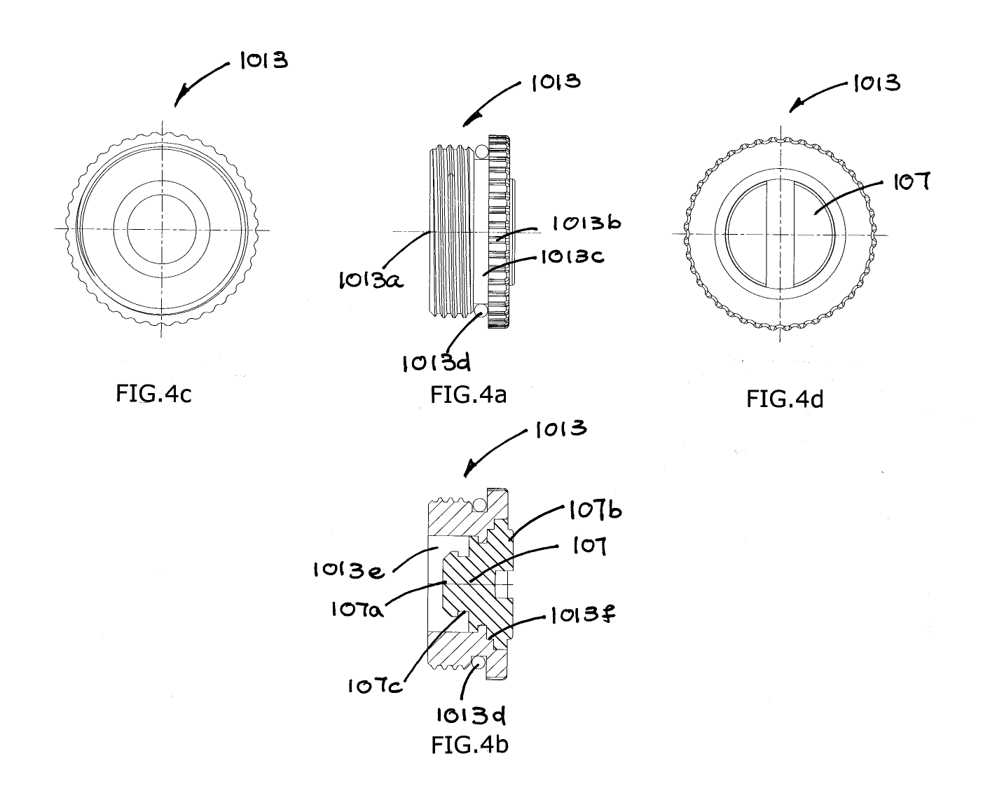

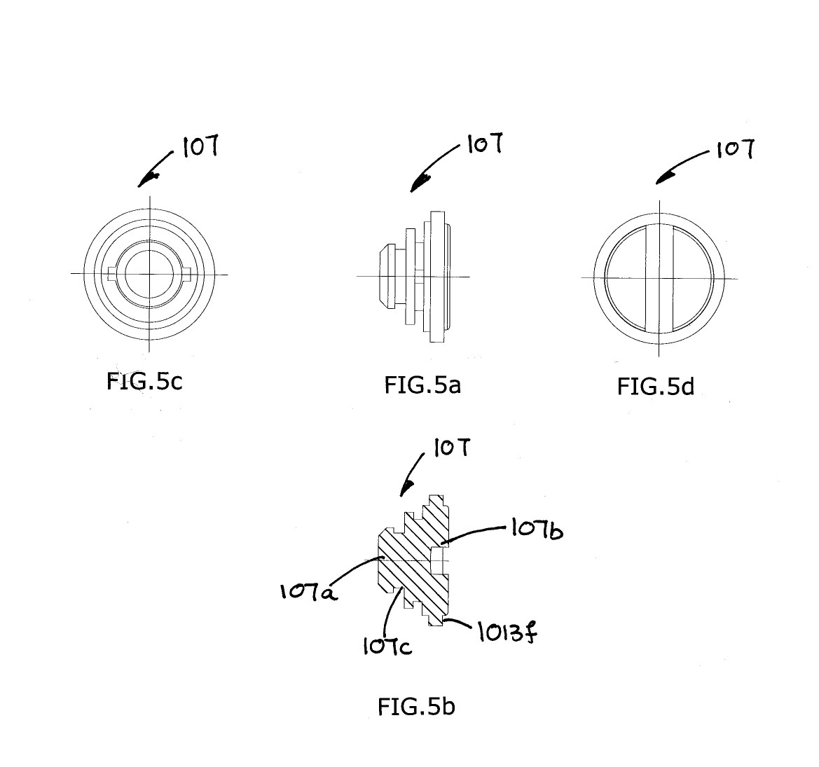

Turning to FIGS. 4a to 4d, the second end cap 1013 is adapted for releasable complementary threaded engagement to the second end 101b of the plastic casing 101. The second end 101b of the plastic casing 101 is closable by the second end cap 1013 which is openable from the second end 101b for allowing introduction of the liquid through the second end 101b into a cavity 111 of the plastic casing 101 to activate the liquid-activatable powder mixture 104. In an alternative embodiment, the second end cap 1013 could be releasably engaged by other suitable engagement means. In more detail, the second end cap 1013 has a threaded portion 1013a for releaseable threaded engagement with the second end 101b of the plastic casing 101, and a ribbed flange 1013b for gripping by a user's fingers. Between the threaded portion 1013a and the flange portion 1013b is a neck portion 1013c for accommodating an O-ring 1013d. When the second end cap 1013 is screwed onto the plastic casing 101, the O-ring 1013c is disposed there between for sealing purposes. As shown in FIG. 4b, the second metal cap 107 is fittedly embedded within a through-hole 1013e that extends along length of the second end cap 1013. In the preferred embodiment as shown in FIGS. 4 and 5, the second metal cap 107 is held securely in the through-hole by inter-engagement features 1013f adjacent its second end 107b. Opposite the second end 107b is a first end 107a sandwiching a neck portion 107c. The first end 107a is physically connected with the second end 102b of the metal casing 102 and the second end 107b is extended beyond the second end cap 1013 for establishing electric contact with an external load.

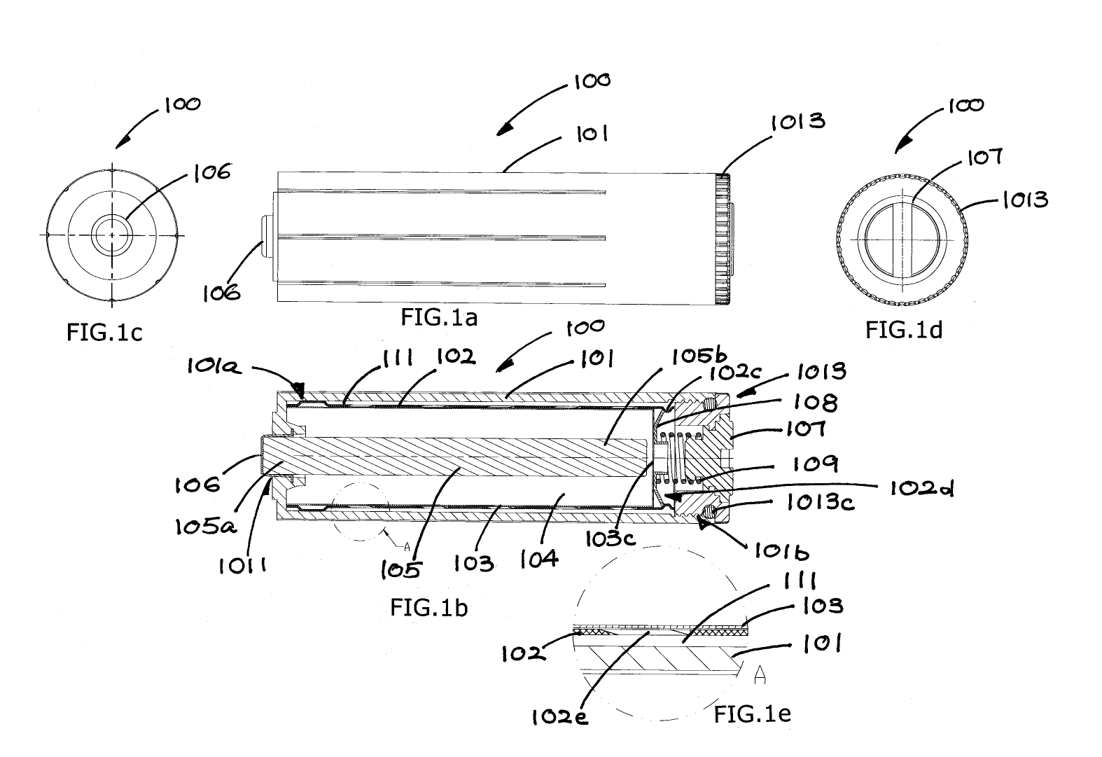

Referring to FIG. 1a to 1d, the first end 107a abuts an anchor preferably in the form of a resiliently deformable locking means 108, preferably electrically conducting, when the second end cap 1013 is screwed onto the plastic casing 101. The first end 107a is physically connected with the second end 102b of the metal casing 102 by the action of the anchor 108 acting against the metal casing 102. A resilient deformable member 109, preferably electrically conducting, securely connects the second metal cap 107 to the anchor 108. A first end 109a of the conducting resilient deformable member 109 is securely connected to the anchor 108 while a second end 109b of the conducting resilient deformable member 109 is securely connected to the neck portion 107c of the second metal cap 107. In other words, the first end 107a is physically, and preferably electrically, connected to the second end 102b of the metal casing 102 by the conducting resilient deformable member 109.

To avoid the second end cap 1013 from completely disengaging from the rest of the battery 100 to form a small part swallowable by for example young children or animals, it is permanently and securely connected physically/mechanically, and preferably electrically, to the rest of the battery 100, more specifically the metal casing 102, by the combined action of the anchor 108 and the conducting resilient deformable member 109 which act on the second metal cap 107. Despite that, the second end cap 1013 is releasably screwed onto the second end 101b of the plastic casing 101 such that liquid can be added to the reaction mixture 104 through the access created by releasing the second end cap 1013 when it is unscrewing from the plastic casing 101.

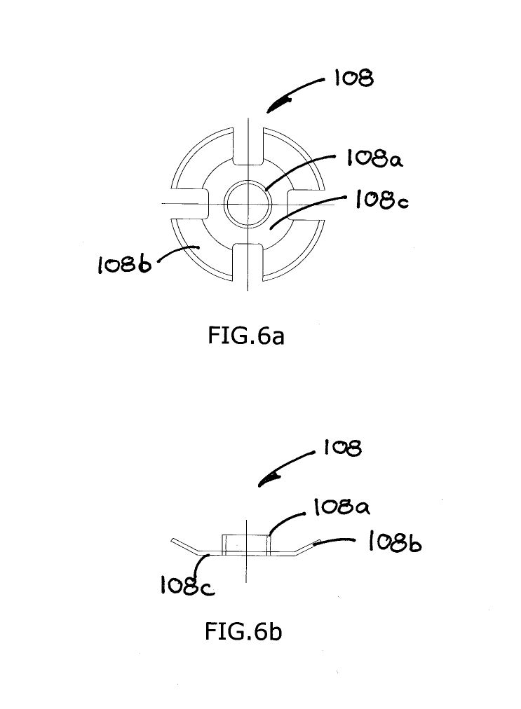

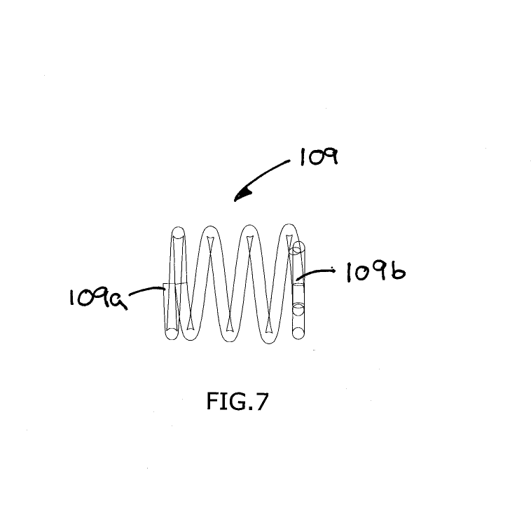

In the preferred embodiment, Referring to FIGS. 5a to 7, the anchor 108 takes the shape of a frusto-conical disc with a central cylindrical portion 108a having same height as the slanted circular side edge 108b of the anchor 108, and the side edge 108b has four dents extending from its upper rim to part of a central circular plate 108c defining a central aperture around which the cylindrical portion 108a extends centrally upward. The anchor 108 is formed from zinc and the central cylindrical portion 108a is fixedly secured to the first end 109a of the resilient deformable member 109. A first surface of the central circular plate 108c lies flat on a second end plate 103c of the liquid permeable separator 103 while the upper rim of the side edge 108 abuts an interior surface of a second end flange 102c of the second end 102b of the metal casing 102. The anchor 108 is electrically and physically connected to the metal casing 102. Referring to FIG. 7, the resilient deformable member 109 is a biasing means in the form of a helical spring. The second end 109b of the helical spring 109 is fixedly secured onto the neck portion 107c of the second metal cap 107 to thereby permanently electrically and physically/mechanically connect the anchor 108 and the second metal cap 107.

When the second end cap 1013 is screwed onto the plastic casing 101, the helical spring 109 is compressed. When the second end cap 1013 is unscrewed from the plastic casing 101, the helical spring 109 is relaxed but remain connected physically/mechanically and electrically to the conducting locking means, hence the metal casing 102.

The slanted circular side edge 108b of the anchor 108 is resiliently deformable (a resiliently deformable portion) and formed from metal. The shape of the resiliently deformable portion 108b and its resilient characteristic are advantageous as it is deformable to be inserted through the aperture 102d defined by the second end flange 102c of the metal casing 102. Once inserted, the resilience of the resiliently deformable portion 108b returns it to its default undeform (expanded) shape preventing the anchor 108 from passing the aperture 102d and preferably remains abutted with the second end flange 102c of the metal casing 102 to form a secured connection at least when the second end cap 1013 is pulled away from the second end 102b of the metal casing 102. This is a one-step snap fit connection, which minimizes time and costs in production of the battery 100, to permanently, physically, mechanically and electrically connects the second end cap 1013 to the rest of the battery 100.

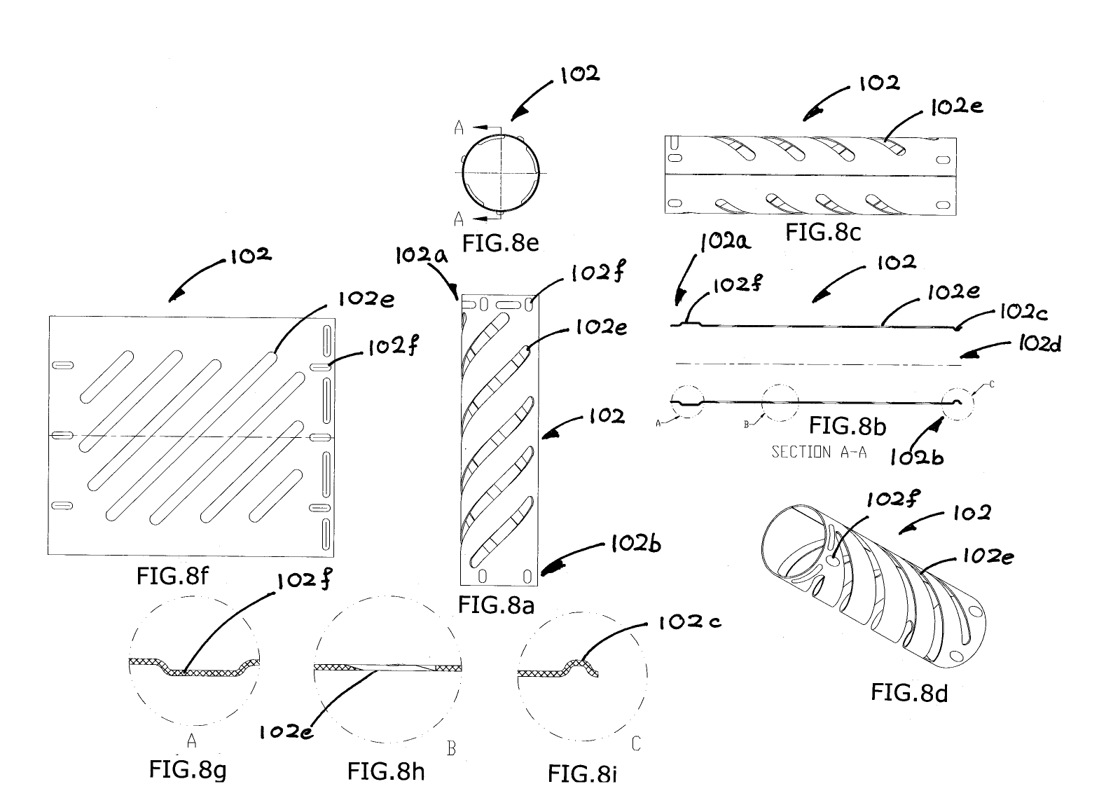

The metal casing 102, as shown in FIGS. 8a to 8e, is generally a cylindrical tube with open first and second ends 102a and 102b. The second end 102b has in turned second end flanges 102c. The metal casing 102 is preferably made of die cast zinc sheet and formed by rolling into the preferred cylindrical shape. On a peripheral wall of the metal casing 102 there is at least one, preferably a plurality of evenly distributed, slanted elongate through-hole 102e. These through-holes 102e are die casted into the zinc sheet. Inner side of the metal casing 102 is lined by a liquid permeable separator 103 in the form of a paper membrane. A cavity 111 is defined between the plastic casing 101 and the metal casing 102 where liquid may be temporarily retained around whole of the periphery of the metal casing 102. The through-holes 102e permits liquid to directly enter the reaction mixture 104 through the through-holes 102e and the liquid permeable separator 103. As would be appreciated, the surface area of the reaction mixture 104 which water is able to contact with and penetrate into is considerably greater than in the case of certain prior art batteries. The through-holes 102e and the cavity 111 together define a first passage extending between the first and second ends 101a and 101b of the plastic casing 101 to allow a flow of liquid therethrough when the second end cap 1013 is unsealed. Also, there is a number of evenly sized projections 102f from the outer surface of the metal sheet 102 which are provided to abut inner surface of the plastic casing 101 when assembled for fixing the position of the metal sheet 102 relative to the plastic casing 101. This would be useful in maintaining the size or dimension of the cavity 111 substantially even across the outer surface of the metal sheet 102 and the inner surface of the plastic casing 101.

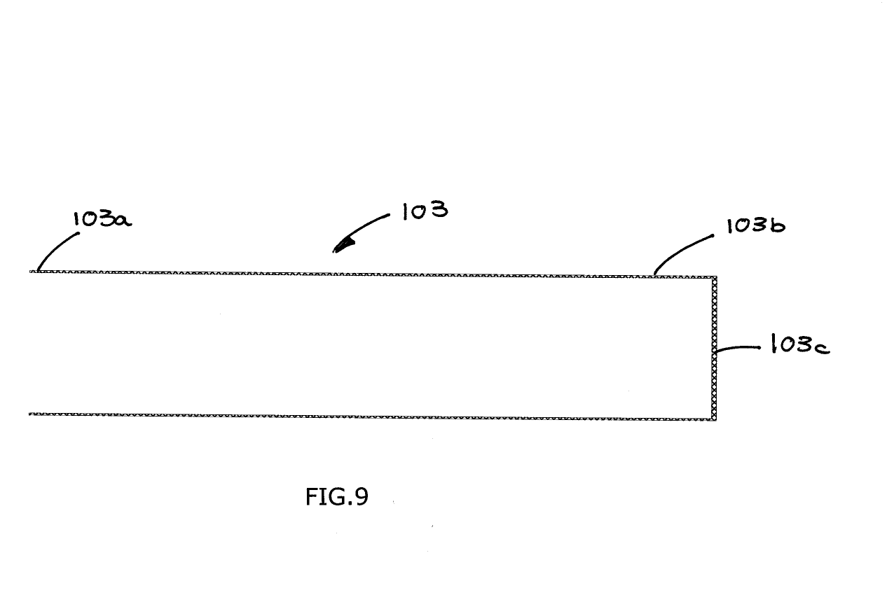

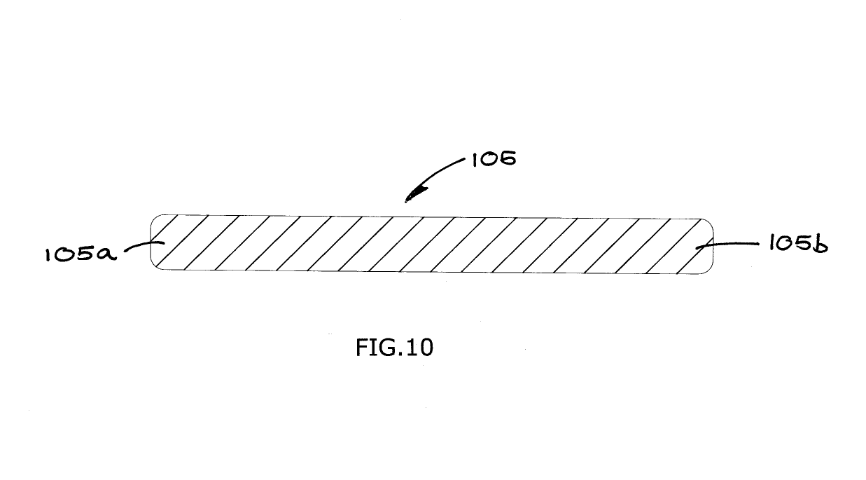

Turning to FIG. 9, there is shown an enlarged drawing of the liquid permeable separator 103. It is again generally cylindrical in shape dimensioned to line the interior of the metal casing 102. It has a first open end 103a and an opposite second end 103b closed by the second end plate 103c. The reaction mixture 104 is packed in the internal space defined by the liquid permeable separator 103 and around the carbon stick 105 which is generally cylindrical. The carbon stick 105 may be formed from any suitable material other than carbon. In addition to the first passage, a second passage is established by the second end plate 103c, the opening 102d on the anchor 108 and the central cylindrical portion 108a which is hollow. The central cylindrical portion 108a and the opening 102d on the anchor 108 are in alignment with the second end plate 103c. The liquid comes into contact with the reactive mixture 104 through them when the second end cap 1013 is unsealed and the second end plate 103c is opened to the external environment.

In the preferred embodiment, the liquid-activatable powder mixture 104 is made up of 8 to 12% carbon powder C₂H₂, 72-76% Manganese Dioxide Mn₂ powder and 14-18% Zinc Chloride ZnCl₂ powder. The mixture 104 is not reactive until liquid such as water is added thereto. Upon addition of water, the mixture 104 forms the electrolyte of the battery 100 which produces about 800 mAh. A dry battery 100 has an e.m.f. of about 1.5-1.7V.

In the prior art batteries, the reaction mixture 104 is a packed mix of powdered ingredients. As the density of the ingredients is high, the closely packed ingredient particles prevent or deter water from penetrating. The battery is required to be soaked in water for at least 5-7 minutes before the water soaked battery is ready for use with 50% of the mixture activated. In the preferred embodiment of the invention, the water soaking time is reduced almost by half. This is achieved by pre-forming the ingredients into relatively small separate lumps of powder reactive mixture 104 preferably in the form of evenly sized balls.

The ingredients of the liquid-activatable powder mixture 104 are ball milled into powder form with particle size of 20 to 100 micrometer in diameter and a density of 0.5 to 1.0 g/cm³, kept at a relative humidity of 0 to 2%. The liquid-activatable powder mixture 104 is that pressed into compacted powder balls with a diameter of 0.1 to 0.8 millimeter and a density of 1.0 to 1.8 g/cm³. These balls are again kept at a relative humidity of 0 to 2% and s filled into the liquid permeable separator 103 and compressed to 5g-6g net powder weight. As there are spaces between the packed balls, liquid or water can better penetrate the reactive mixture 104 to reduce the time for soaking to 3 minutes with about 50% of the mixture activated while permitting a better power output at 800 mAh. Further soaking will not substantially increase the percentage. Once the battery is dried out, it can be re-soaked into water for activating the rest of the ingredients.

Chemicals function and reaction:

The carbon stick 105 collects the returning electrons. Manganese dioxide is mixed with carbon powder to increase the electric conductivity by acting as a barrier to polarization. Electrons are less likely to reduce the manganese atoms but rather stay in the charge flow. Zinc is used because of its stability.

Before liquid or water enters the battery 100, it produces 0 voltage. After liquid or water is add, the battery 100 produces a voltage of 1.5 to 1.7 V. when the chemical reaction in the reactive mixture 104 completes, the battery 100 stops producing powder.

During the reaction:

Zn(s)→Zn₂+(aq)+2e−

2MnO₂(s)+H₂O+2e−→Mn₂O₃(s)+2OH− (aq)

and Cl− combines with Zn2+

The overall reaction is represented by:

2MnO₂(s)+Zn+H₂O→Mn₂O₃(s)+Zn₂+(aq)+20H− (aq)

Side reaction and depletion of the active chemical increases the internal resistance of the battery and causes the e.m.f. to drop.

Carbon takes no part in the electrochemical reaction but to collect current and reduce resistance of the reactive mixture with manganese oxide.

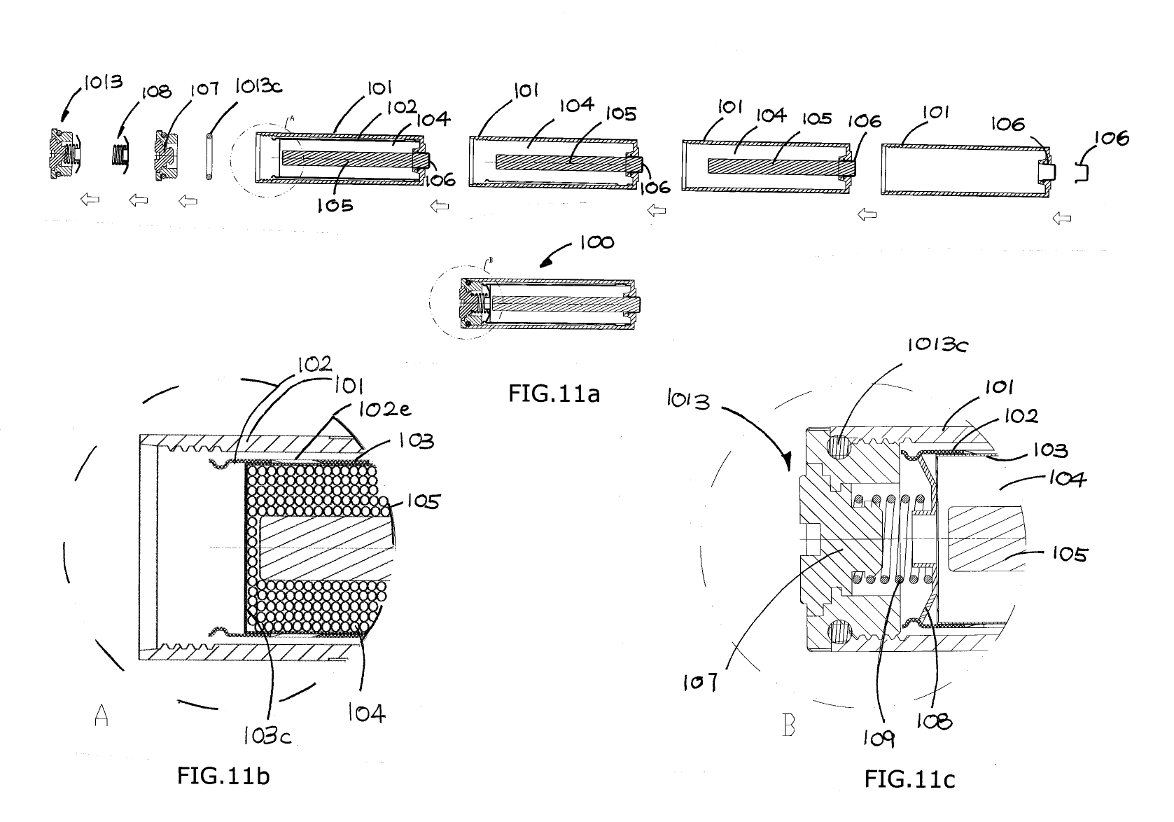

The method of manufacture is described as follow with reference to FIGS. 11a to 11c. The copper cap 106 is inserted into the plastic casing 101 during injection moulding. The die cast second metal end cap 107 is inserted into second end cap 1013 during injection molding. The O-ring 1013d is sleeved onto the second end cap 1013. The carbon stick 105 is then inserted. The metal casing (zinc) 102 is formed and treated by soaking in a bath of Indium Chloride (InCl₃). The bath of Indium Chloride is prepared by mixing 10 g Indium Chloride with 20 liter of water at 90° C. The treated metal casing 102 is inserted into the plastic casing 101. The liquid permeable separator 103 in the form of a cylindrical tube of paper membrane 103 is formed into shape and inserted into the metal casing 102.

The reactive mixture is formed by a) mixing 72-76% of MnO₂ powder, 8-12% of C₂H₂ powder and 14 to 18% of ZnCl₂ powder at 0-2% humidity, b) ball milling the mixed powder into the size of 20 to 100 micrometer with a density of 0.5 to 1.0 g/cm³ at 0-2% humidity and c) pressing the mixed powder into compacted balls evenly sized at 0.1 to 0.8 mm in diameter with a density of 1.0 to 1.8 g/cm³ at 0 to 2% humidity. The balls are then filled into the liquid permeable separator 103 and are compressed to 5g to 6g net powder weight. The end plate 103c is applied to close off the liquid permeable separator 103. In another embodiment, the end plate 103c is pre-formed such that the liquid permeable separator 103 is a cylindrical container. The balls are filled into the container and are compressed to 5g to 6g net powder weight. The second end cap 1013 is connected to the anchor 108 through the helical spring 109. The O-ring is sleeved onto the neck portion 1013c. The second end cap 1013 is installed by forcing the anchor 108 through the aperture 102d and allows the anchor 108 to regain its default shape abutting the flange 102c of the metal casing 102. The second end cap 1013 is then screwed into the plastic casing 101. These steps are kept at a relative humidity of 0-15% and should be completed within 10 minutes.

As is appreciated from the foregoing description, the subject battery and the method of making the same has a minimal construction and is simple and quick to make and use. It is also capable of being activated in a shorter period of time comparing to prior art batteries and produces a higher output.

The invention has been given by way of example only, and various other modifications of and/or alterations to the described embodiments may be made by persons skilled in the art without departing from the scope of the invention as specified in the appended claims.

What is claimed is:

1. A battery comprising:
a body having opposite first and second ends;
a liquid-activatable powder mixture disposed in the body;
a positive electrode, to which cations migrate, comprising a conductive rod which has a first end located adjacent the first end of the body and extends towards the second end of the body in contact with the powder mixture;
a negative electrode, at which anions are oxidized, comprising a metal casing which has a first end located adjacent the first end of the body and extends towards the second end of the body;
a permeable separator, disposed between the liquid-activatable powder mixture and the metal casing, for electrically isolating the negative electrode from the positive electrode while being permeable to liquid useful in activating the powder mixture; and
a passage, extending between the first and second end of the body, for allowing a flow of liquid to activate the liquid activatable powder mixture,
wherein the metal casing is perforated and the passage includes at least one perforation on the metal casing and a cavity which is in communication with the perforation and positioned between the body and the metal casing.

2. The battery as claimed in claim 1, wherein the first end of the body and the first end of the metal casing are sealed by a first end cap.

3. The battery as claimed in claim 2, wherein the first end cap includes a first metal end cap which forms part of the positive electrode.

4. The battery as claimed in claim 3, wherein the first end cap includes an aperture in which the first metal end cap protrudes and in which the first end of the conductive rod embeds.

5. The battery as claimed in claim 1, wherein the second end of the body is closable by a second end cap which is openable from the second end of the body for allowing introduction of said liquid through the second end into the cavity to activate the liquid-activatable powder mixture.

6. The battery as claimed in claim 1, wherein the cavity extends substantially around the metal casing.

7. The battery as claimed in claim 1, wherein the metal casing includes a second end adjacent the second end of the body, the at least one perforation on the metal casing elongates substantially across the first and second ends.

8. The battery as claimed in claim 7, wherein the at least one perforation is die casted on a metal sheet which is rolled to form the metal casing, such that the perforation is spiral.

9. The battery as claimed in claim 1, wherein the flow of liquid is made possible by a further passage which extends directly through a portion of the liquid permeable separator that continues beyond the metal casing.

10. The battery as claimed in claim 9, wherein the portion of the liquid permeable separator extends substantially across the second end of the body for isolating the reactive mixture from external environment.

11. The battery as claimed in claim 5, wherein the second end cap is permanently physically connected to the rest of the battery.

12. The battery as claimed in claim 11, wherein the second end cap remains physically connected by action of an anchor acting against the metal casing.

13. The battery as claimed in claim 12, wherein the second end cap includes a second metal end cap which forms part of the negative electrode.

14. The battery as claimed in claim 13, wherein the second metal end cap has first and second opposite ends, the first end being physically connected with the second end of the metal casing and the second end being extended beyond the second end cap for establishing electric contact with an external load.

15. The battery as claimed in claim 14, wherein the first end of the second metal end cap is physically to the second end of the metal casing by a resilient deformable member.

16. The battery as claimed in claim 15, wherein the resilient deformable member is physically connected to the second end of the metal casing through the anchor.

17. The battery as claimed in claim 16, wherein the anchor includes a resiliently deformable portion and wherein the second end of the metal casing includes a flange which defines an aperture, such that the resiliently deformable portion of the anchor is deformable for insertion through the aperture and expandable for retaining the anchor.

18. The battery as claimed in claim 17, wherein resiliently deformable portion is shaped to act against the flange at least when the second end cap is pulled away from the second end of the metal casing.

19. The battery as claimed in claim 15, wherein the resilient deformable member is electrically conductive such that the second metal end cap is physically and electrically connected to the second end of the metal casing by the resilient deformable member.

20. The battery as claimed in claim 19, wherein the anchor is electrically conductive such that the second metal end cap is physically and electrically connected to the second end of the metal casing by the anchor and the resilient deformable member.

21. The battery as claimed in claim 19, wherein the resiliently deformable member comprises a helical spring.

22. The battery as claimed in claim 12, wherein the anchor lies against the portion of the liquid permeable separator.

23. The battery as claimed in claim 22, wherein the further passage includes an aperture which is defined in the anchor and is in alignment with an aperture which is defined at the second end of the metal casing, the apertures being openable to the external environment when the second end cap is opened to permit the flow of liquid through the further passage.

24. The battery as claimed in claim 1, wherein the reactive mixture is in the form of compacted lumps of reactive ingredients in powder form, each in a preferred dimension.

25. The battery as claimed in claim 24, wherein each compacted lump takes the shape of a ball with an average diameter from 0.1 to 0.8 millimeters.

26. The battery as claimed in claim 24, wherein each compacted lump has a density of 1.0 to 2.0 g/cm³.

27. A battery comprising:
a body having first and second ends, the second end being releasably sealable by a second end cap;
a liquid-activatable powder mixture disposed in the body;
a positive electrode, to which cations migrate, including a conductive rod in contact with the powder mixture and having a first end located adjacent the first end of the body and extending towards the second end of the body;
a negative electrode, at which anions are oxidized, including a metal casing having a first end located adjacent the first end of the body and extending towards the second end of the body;
a permeable separator disposed between the liquid-activatable powder mixture and the metal casing for electrically isolating the negative electrode from the positive electrode while being permeable to liquid useful in activating the powder mixture; and
a passage extending between the first and second end of the body for allowing flow of said liquid to activate the liquid-activatable powder mixture, the passage being accessible by opening of the second end cap;
wherein the second end cap is permanently physically connected to the rest of the battery and is closable with the second end of the body and is openable from the second end of the body for allowing introduction of said liquid through the second end into the body to activate the liquid-activatable powder mixture.

28. The battery as claimed in claim 27, wherein the second end cap remains physically connected by action of an anchor acting against the metal casing.

29. The battery as claimed in claim 27, wherein the second end cap includes a second metal end cap which forms part of the negative electrode.

30. The battery as claimed in claim 29, wherein the second metal end cap has first and second opposite ends, the first end being physically connected with the second end of the metal casing and the second end being protruded from the second end cap for establishing contact with an external load.

31. The battery as claimed in claim 30, wherein the first end of the second metal end cap is physically connected to the second end of the metal casing by a resilient deformable member.

32. The battery as claimed in claim 31, wherein the resilient deformable member is physically connected to the second end of the metal casing through the anchor.

33. The battery as claimed in claim 32, wherein the anchor includes a resiliently deformable portion and wherein the second end of the metal casing includes a flange which defines an aperture, such that the resiliently deformable portion of the anchor is deformable for insertion through the aperture and expandable for retaining the anchor.

34. The battery as claimed in claim 33, wherein resiliently deformable portion is shaped to act against the flange at least when the second end cap is pulled away from the second end of the metal casing.

35. The battery as claimed in claim 31, wherein the resilient deformable member is electrically conductive such that the second metal end cap is physically and electrically connected to the second end of the metal casing by the resilient deformable member.

36. The battery as claimed in claim 35, wherein the anchor is electrically conductive such that the second metal end cap is physically and electrically connected to the second end of the metal casing by the anchor and the resilient deformable member.

37. The battery as claimed in claim 35, wherein the resilient deformable member comprises a helical spring.

38. A battery comprising:
a body having first and second ends;
a liquid-activatable powder mixture disposed in the body;
a positive electrode, to which cations migrate, including a conductive rod in contact with the powder mixture and having a first end located adjacent the first end of the body and extending towards the second end of the body;
a negative electrode, at which anions are oxidized, including a metal casing having a first end located adjacent the first end of the body and extending towards the second end of the body;
a permeable separator disposed between the liquid-activatable powder mixture and the metal casing for electrically isolating the negative electrode from the positive electrode while being permeable to said liquid useful in activating the powder mixture; and
a passage extending between the first and second end of the body for allowing flow of said liquid to activate the liquid activatable powder mixture;
wherein the liquid-activatable powder is in the form of compacted lumps, each in a preferred dimension.

39. The battery as claimed in claim 38, wherein the compacted lump is in the form of a compacted ball which has an average diameter of 0.1 to 0.8 mm.

40. The battery as claimed in claim 39, wherein the compacted ball has a reactive mixture powder density of about 1.0 to 2.0 g/cm³.

41. The battery as claimed in claim 1, wherein the metal casing is pre-treated with indium chloride.

42. The battery as claimed in claim 41, wherein the metal casing is soaked into a bath of indium chloride.
